(19) United States
(12) Patent Application Publication
(10) Pub. No.: US 2007/0150449 A1
(43) Pub. Date: Jun. 28, 2007

(54) Database program acceleration

(76) Inventors: Toshio Suganuma, Yokohama City (JP); Akira Koseki, Sagamihara-shi (JP); Hideaki Komatsu, Yokohama-shi (JP)

Correspondence Address: LIEBERMAN & BRANDSDORFER, LLC, 802 STILL CREEK LANE, GAITHERSBURG, MD, 20878, US

(21) Appl. No.: 11/320,053

(22) Filed: Dec. 28, 2005

(51) Int. Cl. G06F 17/30

(52) U.S. Cl. 707/3

(57) ABSTRACT

A method and system are provided to automatically generating structured query language (SQL) to accelerate program execution in a database. Analysis of a target program checks usage status of objects and field data, and to determine which columns and table of a database record are required for program access. The SQL is generated to return only necessary data based upon which columns of which tables of the database record are likely to be accessed by the program.

### BACKGROUND OF THE INVENTION

1. Technical Field

This invention relates to automatic program acceleration in a database application.

More specifically, the program uses selective column returns from a database and selective data injection into objects that require database access to implement the automatic program acceleration.

2. Description of the Prior Art

In business applications, it is common for multiple applications to access a common database (DB) table. For instance, a banking application will have a database that entirely manages an account table of customers. An online application provides functions to display current account balances and other information or to perform transfer transactions, while a batch application carries out withdrawals for monthly credit card payments or payments of utilities. As for the configuration of the business application in this case, generally, the common object of customer data will be defined so as to be shared among multiple applications.

Processing requests differ slightly between applications. For example, applications that only need a portion of columns in a table may fetch entire columns or columns containing unnecessary data due to using a common object definition. An example of differing applications includes an online program that requires various forms of accompanying information and a batch program. The online program may require account numbers and the last date updated in addition to account balances for display on the web. The batch program may perform withdrawal transactions only for account balance data and does not require other information. Such fetching entire columns due to using the common object definition results in an unnecessary increase of overhead in addition to the direct overhead of the increased amount of data that is returned. The overhead may result in performance degradation of the entire system, depending on the configuration of the database table or the content of the application.

The problem becomes especially more significant when this business logic is repeatedly executed. For example, batch processing has the characteristic of executing the same process repeatedly for a vast amount of data, for example, several millions or tens of millions of data records. Accordingly, if the aforementioned problem occurs in the data return of each record on the database table, it may result in serious performance degradation of the entire application.

One prior art solution is a manual optimization technique which defines objects individually in each application. This process specifies only columns used in the business logic within the application by defining objects individually in each application. By processing only necessary data, the overhead of unnecessary data fetching or type conversions will be reduced, regardless of other applications. However, one drawback with this method is that objects in a database are generally shared among applications, and the process of individually defining objects removes this shared characteristic. If multiple applications on an application server are executed simultaneously and they access the same data, each application will send a query and individually return data causing a conflict if the objects are defined individually. Accordingly, there is a need for a solution that supports defining a common object while enabling sharing of the defined objects among multiple applications.

Another prior art solution is a manual solution which conducts a partial hydration wherein a programmer specifies the field group of each object to be fetched. In the case that the application accesses an unfetched field of an object, a secondary query is performed at that point and execution is continued after additional data is returned on-the-fly and injected into the object, i.e. lazy hydration. However, there are limitations with this prior art method in that it requires a programmer who is very familiar with the application content to explicitly specify the groups, thereby imposing a burden on the programmer. The program will operate properly at the time of execution by preparing the mechanism of lazy hydration even if a field that is not fetched at the initial time is accessed. However, if this occurs, a query will be sent twice to the same object and performance is likely to be degraded. Sorting field groups and specifying groups for the finder so as to prevent lazy hydration occurrence at the time of execution is difficult, and it is prone to errors when working manually. In addition, to prevent lazy hydration from being performed, fields that are not frequently access need to be initially included in the field groups, resulting in the problem of reducing overhead for unnecessary data fetch and type conversion.

As explained above, although there are advantages to defining a common object, such as enhancing the maintainability and extensibility of the system, there will conversely be the problem of degradation of application performance. Accordingly, there is a need for a solution that removes the burden of manual programming while preserving the shared nature of database accessibility.

### SUMMARY OF THE INVENTION

This invention comprises a method and apparatus for automatic program acceleration that requires database access.

In one aspect of the invention, a method is provided for program acceleration that includes statically analyzing a target program during deployment. The process of analyzing the target program includes checking usage status of each object that is to be used along with its field data from among objects that will realize a database record. In response to the analysis, it is determined which columns of which tables of the database record are likely to be accessed by the program. Based upon the analysis and determination, SQL (Structured Query Language) that fetches only necessary data is automatically generated.

In another aspect of the invention, a computer system is provided with a target program to be statically analyzed during deployment. The analysis of the target program checks usage status of each object that is to be used along with its field data of the object that will realize a database record. The system includes a data manager adapted to determine which columns of which tables of the database record are likely to be accessed by the program. In addition, an SQL manager is provided to automatically configure SQL to return only necessary data in response to the data manager determination.

In yet another aspect of the invention, an article is provided with a computer readable medium. Means in the medium are provided having computer readable code. Instructions are provided to statically analyze a target program during deployment. These instructions check usage status of each object that is to be used along with its field data of the object that will realize a database record. Instructions are also provided to determine which columns of which tables of the database record are likely to be accessed by the application. In addition, instructions are provided to automatically generate SQL responsive to the access determination that fetches only necessary data.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a flow chart illustrating program analysis and execution according to the preferred embodiment of this invention, and is suggested for printing on the first page of the issued patent.

FIG. 2 is a flow chart illustrating a process for generating SQL.

FIG. 3 is a flow chart illustrating initialization of objects above a threshold.

FIG. 4 is a flow chart illustrating initialization of objects below a threshold.

FIG. 5 is a flow chart illustrating initialization of an object using query results that have selectively returned columns.

### DESCRIPTION OF THE PREFERRED EMBODIMENT

### Overview

In a database application, both data fetch overhead and type conversion overhead are reduced when obtaining data from the database. Type conversion occurs with mixing of different data types in the same expression. With respect to mitigation of data fetch overhead, structured query language (SQL) that is utilized to access the database is automatically generated to fetch only columns of the database that are necessary for the given application. Similarly, with respect to mitigation of type conversion overhead, values are injected only into fields of the database with a high probability of being accessed from among the returned data.

### Technical Details

Reduction of overhead occurs in two stages. In the first stage, structured query language (SQL) is automatically generated based on a detection of field access of database objects in the program. This first stage minimizes overhead of the data results. The second stage involves injecting values into object fields with a high access probability from among the data returned in the first stage by the SQL.

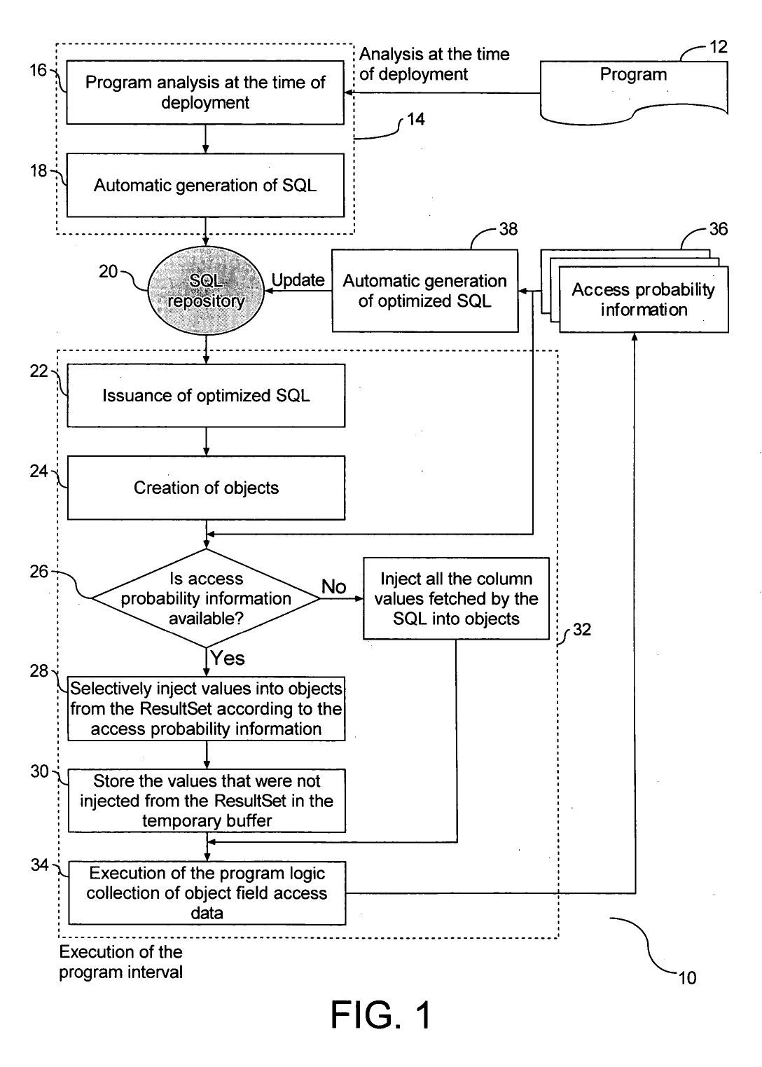

Program analysis during the time of deployment and generation of optimal SQL is performed to automatically generate the SQL. Overhead associated with access to a database is reduced by automatically generating SQL that returns only columns of a database table that are necessary for each application, and by injecting values into object fields with a high probability of being accessed from among the returned data. FIG. 1 is a flow chart (10) illustrating the general aspects of the invention. Initially, a program utilizing database resources is deployed (12). A static analysis of the entire target program is carried out during the time of program deployment (14). The static analysis includes checking the usage status of each object that is to be used along with its field data of the object that will realize the database record, i.e. database object (16). Following step (16), a determination is made as to which columns of which tables are likely to be accessed by the application. Thereafter, SQL is automatically generated to fetch only necessary data (18) based upon the analysis at step (16). The SQL may be dynamically updated based upon changes in situations, and the updated SQL may replace the SQL generated based upon the analysis during the initial program deployment (12). For example, SQL may need to be changed to reflect lazy hydration or when access is made to object fields during program execution. Both analyses at steps (16) and (18) take place at the time of program deployment. Following step (18), an SQL repository is investigated to obtain table information, such as primary keys, data types, and data sizes (20) followed by execution of the program utilizing the SQL. Steps (22)-(34) demonstrate the processes that accompanies the execution of the program. Following investigation of the SQL repository, optimized SQL is issued (22) and objects are created (24). Thereafter, a test is conducted to determine if access probability information is available for the result set, i.e. an object created (26). A positive response to the test at step (26) results in selectively injecting values into the object from the result set with a high probability of being accessed (28), and storing the values that were not injected from the result set in a temporary buffer (30). If, during program execution, access was performed in a path having a low execution probability and data are found in the temporary buffer, this data may be retrieved and values may be injected into the relevant fields of the objects with performing type conversion. Similarly, if data is not found in the temporary buffer, data are retrieved from the relevant database table at the time of execution. However, if the response to the test at step (26) is negative, all the column values of the result set returned by the SQL are injected into objects (32). Following steps (30) and (32), the program logic is executed and object field access data is collected (34). The process of collecting object field access data is collated and processed into access probability information (36) which is utilized to automatically generate optimized SQL (38). Accordingly, the process of automatically generating SQL includes optimizing the SQL based upon a collection of access data.

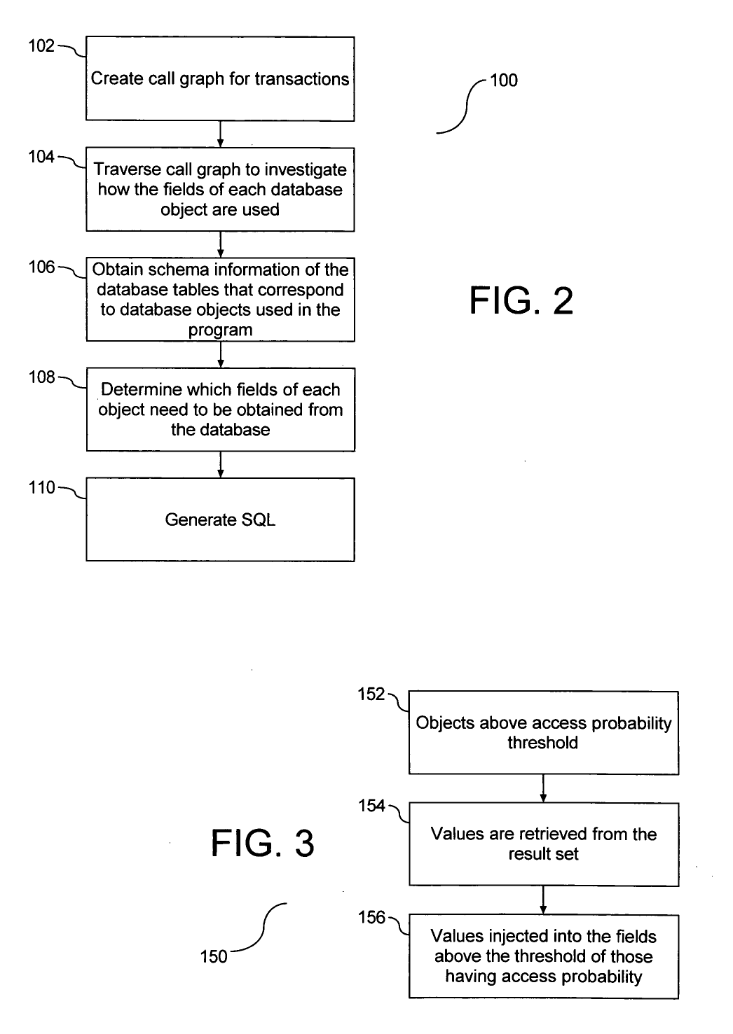

As shown at step (38) in FIG. 1, SQL is automatically optimized and generated. In order to automatically generate SQL based on the detection of field access of database objects, program analysis during the time of deployment of the program is performed. FIG. 2 is a flow chart (100) illustrating a process for generating SQL. A call graph is created for a transaction (102). The call graph represents calls between entities in a given program. In one embodiment, a call graph is a diagram that identifies the modules in a system or program and shows which modules call one another. Following step (102), the created call graph is traversed to investigate how the fields of each database object are used (104). In a JAVA programming environment, a data flow equation for each field of each bean is solved by using a reference method call and a setter method call for a collection of information. In one embodiment, when propagating data during data flow analysis, data regarding the execution probability of each field of the objects can be obtained by setting a flag on basic blocks along branches of the execution probability that are lower than a certain threshold and clearing the flag that is merged with paths having a high execution probability. The database table schema information that corresponds to database objects used in the program of the database tables is obtained (106). Such information includes a primary key, a data type, and a size of all the columns. Based upon the call graph traversal at step (104) and the schema information obtained at step (106), a determination is made as to which fields of each object need to be obtained from the database (108). In one embodiment, the primary key fields need to be obtained even if it is not explicitly used in the application. This is because the primary key field may be used as a hash value when performing look-ups after objects are created and registered in the cache. Following the determination at step (108), SQL is generated (110). Accordingly, SQL is generated based on detection of field access of database objects in the program.

As noted above, there are two processes that occur at the time of execution. One process automatically generates SQL, and another process initializes objects using access probability information of the object fields. In order to automatically generate optimized

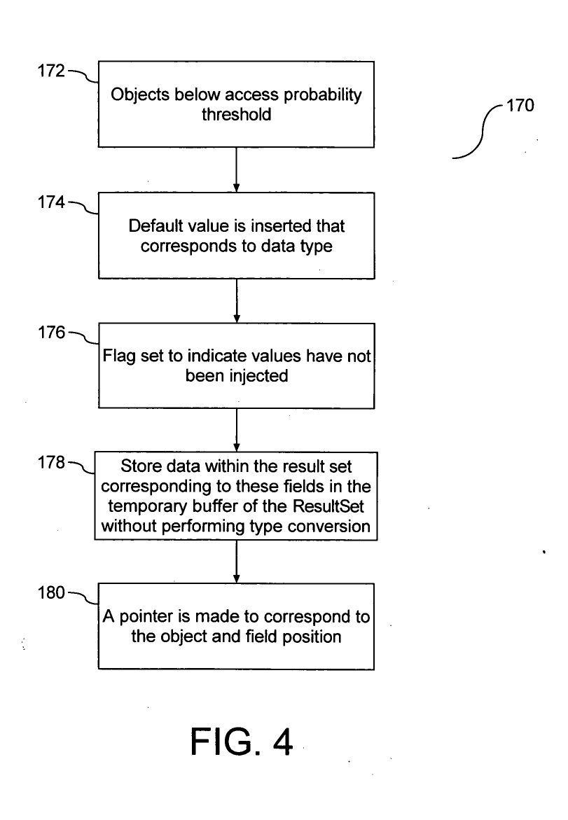

As noted above, there are two processes that occur at the time of execution. One process automatically generates SQL, and another process initializes objects using access probability information of the object fields. In order to automatically generate optimized SQL that fetches only necessary data, program analysis is performed to determine which columns and/or which tables are likely to be accessed. In addition, objects are initialized using the access probability information of the object field with the result set returned upon issuance of the generated SQL. This is shown in FIG. 1 at steps (28)-(32). FIG. 3 is a flow chart (150) showing details of the process for initialization of objects using access probability information. More specifically, FIG. 3 demonstrates initialization of objects above a defined threshold. A set of objects above an access probability threshold are defined (152) and values are retrieved from the results set (154). Following the retrieval at step (154), values are injected into the fields above the threshold of those having access probability (156). FIG. 4 is a flow chart (170) showing details of the process for initialization of objects using access probability information, wherein the objects are below a defined threshold. For fields which are below the threshold for having access probability (172), a default value is inserted into those fields that corresponds to the data type (174), and a flag is set to indicate that values have not been injected (176). In one embodiment, the default value may be NULL or 0. Following step (176), data is stored within the result set corresponding to these fields in a temporary buffer of the result set without performing type conversion (178), and a pointer is created that corresponds to the object and field position (180).

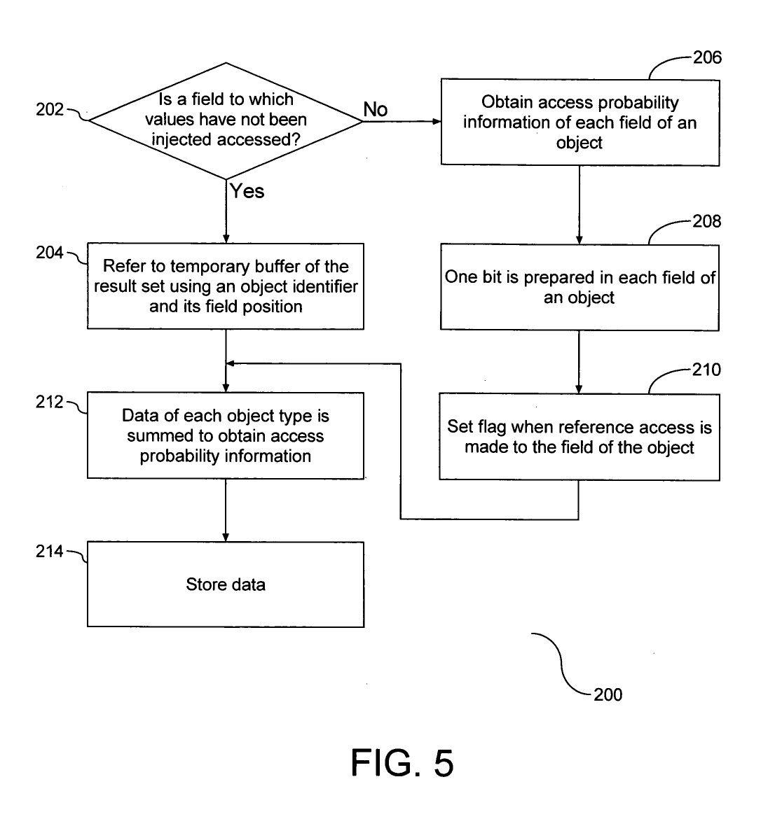

While objects are being initialized in FIGS. 3 and 4, a mapping table of the data position and the object field position in the result set is created to select columns, and values are injected with reference to this table in order to retrieve data that corresponds to each field of the object and the object is properly initialized. FIG. 5 is a flow chart (200) illustrating initialization of an object using query results that have selectively fetched columns. Initially, a test is conducted to determine if a field to which values have not been injected is accessed during execution (202). A positive response to the test at step (202) results in the temporary buffering of the result set being referred to using the object identifier and its field position (204). If the response to the test at step (202) is negative, access probability information for each field of an object is obtained (206). One bit is prepared in each field of an object (208). A flag is set when reference access is made to the field of the object during program execution (210). The setting of the bit and flag at steps (208) and (210), respectively, is performed continuously during program execution. At the end of a defined interval, the data of each object type is summed to obtain access probability information concerning each object during program execution (212). The summed information is stored as data of the past several intervals (214). The stored information is referred to when dynamically generating and/or updating SQL before the start of the next program interval, or when injecting values into fields after creating objects during the next program interval. In one embodiment, values from results sets that fall below an intermediate threshold after objects are created are not injected. This allows for performance improvement through selective column fetch and selective column data injection according to dynamic behavior. In the case of lazy hydration due to a change in program behavior, the SQL is re-updated to include the corresponding column. For fields not accessed during certain intervals, value injection is first stopped and then excluded from the target SQL. Accordingly, based on the object field access information of certain past intervals, SQL is dynamically generated and updated, while excluding field data that falls below a defined threshold.

In a preferred embodiment, the invention is implemented in software, which includes, but is not limited to, firmware, resident software, microcode, etc. With respect to software elements, both a data manager and an SQL manager are provided that reside within memory. The managers may include instructions and/or program code for invoking the algorithms outlined and discussed above. Similarly, in a hardware environment, the managers may reside external to memory.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

Embodiments within the scope of the present invention also include articles of manufacture comprising program storage means having program code encoded therein. Such program storage means can be any available media which can be accessed by a general purpose or special purpose computer. By way of example, but not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, wireless and Ethernet adapters are just a few of the currently available types of network adapters.

### Advantages Over The Prior Art

The processes described herein automatically reduces overhead of fetching data and type conversion through generating optimized SQL using selective column fetch by program analysis without user specification. In addition, further overhead is reduced by injecting values based on access probability of each field of database objects. Dynamic behavior changes of the program or data input are adjusted through dynamically updating SQL or injecting values into objects based on data obtained by constantly recording the access status of each object during program execution.

### Alternative Embodiments

It will be appreciated that, although specific embodiments of the invention have been described herein for purposes of illustration, various modifications may be made without departing from the spirit and scope of the invention. In particular, the invention should not be limited to use of structure query language. The invention may be employed to generate and analyze any kind of database query language. Accordingly, the scope of protection of this invention is limited only by the following claims and their equivalents.

We claim:

1. A method comprising the steps of:
(a) statically analyzing a target program during deployment to check usage status of each object that is to be used along with its field data from among objects that will realize a database record;
(b) determining which columns of which tables of the database record are likely to be accessed by the application; and
(c) automatically generate SQL that returns only necessary data.

2. The method of claim 1, further comprising dynamically updating SQL based upon access made to object fields during program execution.

3. The method of claim 1, further comprising performing type conversion from among said returned data.

4. The method of claim 3, further comprising injecting values into objects with a high probability of being accessed when creating corresponding object instances.

5. The method of claim 4, further comprising storing non-high access probability data in a temporary buffer of the result set without conversion.

6. The method of claim 5, further comprising retrieving data from said temporary buffer if there is access to an object field in which values are not injected, and injecting values into relevant fields of the object.

7. The method of claim 1, further comprising recording access status of object fields and identifying situations where access to fields are not selected and dynamically updating the SQL.

8. A computer system, comprising:
a target program adapted to be statically analyzed during deployment, wherein said analysis checks usage status of each object that is to be used along with its field data from among objects that will realize a database record;
a data manager adapted to determine which columns of which tables of said database record are likely to be accessed by the program; and
an SQL manager adapted to automatically generate SQL configured to return only necessary data responsive to the data manager determination.

9. The system of claim 8, wherein said SQL manager is adapted to dynamically update said SQL based upon access made to object fields during program execution.

10. The system of claim 8, wherein said data manager is adapted to perform type conversion from among said returned data.

11. The system of claim 10, further comprising objects with a high probability of being access when creating corresponding object instances adapted to be injected.

12. The system of claim 11, further comprising a temporary buffer adapted to store non-high access probability data of the result set without conversion.

13. The system of claim 12, wherein said data manager is adapted to retrieve data from said temporary buffer if there is access to an object field in which values are not injected, and inject values into relevant fields of the object.

14. The system of claim 8, wherein said data manager is adapted to record access status of object fields and identify situations where access to fields are not selected and to communicate with said SQL manager to dynamically update the SQL.

15. An article comprising:
a computer readable medium;
means in the medium having computer readable code comprising:
instructions for statically analyzing a target program during deployment to check usage status of each object that is to be used along with its field data from among objects that will realize a database record;
instructions for determining which columns of which tables of said database record are likely to be accessed by the application; and
instructions for automatically generating SQL that returns only necessary data.

16. The article of claim 15, further comprising instructions in the medium for dynamically updating SQL based upon access made to object fields during program execution.

17. The article of claim 15, further comprising instructions in the medium for performing type conversion from among said returned data.

18. The article of claim 17, further comprising instructions in the medium for injecting values into objects with a high probability of being accessed when creating corresponding object instances.

19. The article of claim 18, further comprising instructions in the medium for storing non-high access probability data in a temporary buffer of the result set without conversion.

20. The article of claim 19, further comprising instructions in the medium for retrieving data from said temporary buffer if there is access to an object field in which values are not injected, and injecting values into relevant fields of the object.
